(19) United States
(12) Patent Application Publication
(10) Pub. No.: US 2007/0298759 A1
(43) Pub. Date: Dec. 27, 2007

(54) Alarm device for mobile phone

(75) Inventors: Guangyu Lu, Shanghai (CN); Simon Xian Sheng Ye, Shanghai (CN)

Correspondence Address: ANNA WU, P.O. BOX 93286, CITY OF INDUSTRY, CA, 91715, US

(73) Assignee: Jing Dragon Technology (Shanghai) Co., Ltd

(21) Appl. No.: 11/479,391

(22) Filed: Jun. 30, 2006

(30) Foreign Application Priority Data
Jun. 22, 2006 (CN) 200610028001.2

(51) Int. Cl. H04M 11/04

(52) U.S. Cl. 455/404.1

(57) ABSTRACT

An alarm device for a mobile phone includes a receiver for receiving a signal transmitted from a transmitter of a mobile phone only if the receiver is located within a predetermined distance from the mobile phone, an alarm unit for generating an alarm signal, a timing circuit for measuring a predetermined time duration and triggering the alarm unit upon elapse of the predetermined time duration, and a microprocessor for prestoring a subscriber identification module number therein, checking if the mobile phone identification number contained in the signal received by the receiver is identical with the prestored subscriber identification module number, and resetting the predetermined time duration of the timing circuit if the mobile phone identification number contained in the signal received by the receiver is identical with the prestored subscriber identification module number.

### BACKGROUND

1. Field of the Invention

The present invention relates to alarm devices, and particularly to an alarm device for preventing loss or theft of a mobile phone.

2. Description of Related Art

Mobile telephones are continually being developed. The mobile telephones are smaller, less expensive to manufacture and operate and offer more functions and services. Accordingly, mobile telephones have become increasingly popular and their use is increasing. However, it has been found that the mobile phones are subject to loss by their respective owners due to the fact that they are cordless, small, and easy to misplace or forget. Thus, a need exists in the art for a system for preventing such loss or misplacement, as well as theft.

In view of the above, it is clear that there exists a need in the art for a device and corresponding method for preventing loss, misplacement, or theft of mobile phones.

### SUMMARY

In one aspect of the present invention, an alarm device is provided. The alarm is for preventing loss of theft of a mobile phone. The mobile phone has a transmitter for transmitting a signal to a base station thereby establishing a connection therebetween. The signal contains a subscriber identification module number associated with the mobile phone. The alarm device includes a receiver, an alarm unit, a timing circuit, and a microprocessor. The receiver is configured for receiving the signal transmitted from the transmitter of the mobile phone only if the receiver is located within a predetermined distance from the mobile phone. The alarm unit is configured for generating an alarm signal. The timing circuit is configured for measuring a predetermined time duration and triggering the alarm unit upon elapse of the predetermined time duration. The microprocessor is configured for prestoring a subscriber identification module number therein, checking if the mobile phone identification number contained in the signal received by the receiver is identical with the prestored_subscriber identification module number subscriber identification module number, and resetting the predetermined time duration of the timing circuit if the mobile phone identification number contained in the signal received by the receiver is identical with the prestored subscriber identification module number.

The alarm device may further includes a battery and a voltage comparing circuit. The battery is configured for powering the alarm device. The voltage comparing circuit is configured for monitoring a voltage of the battery, and triggering the alarm unit if the voltage of the battery is lower than a predetermined comparison voltage. The alarm signal may be in a form selected from the group consisting of a sound alarm signal, a visual alarm signal, a vibration alarm signal and any combination thereof.

In another aspect of the present invention, a method for preventing loss or theft of a mobile phone is provided. Likewise, the mobile phone has a transmitter for transmitting a signal to a base station thereby establishing a connection therebetween. The signal contains a subscriber identification module number associated with the mobile phone therein. The method includes the steps in no particular order of:
prestoring a subscriber identification module number therein;
measuring a predetermined time duration;
receiving the signal transmitted from the transmitter of the mobile phone only if within a predetermined distance from the mobile phone;
checking if the mobile phone identification number contained in the signal received is identical with the prestored subscriber identification module number;
resetting the predetermined time duration if the mobile phone identification number contained in the signal received is identical with the prestored subscriber identification module number; and
generating an alarm signal upon elapse of the predetermined time duration.

In still another aspect of the present invention, a mobile phone set is provided. The mobile phone includes a mobile phone and an alarm device. The mobile phone includes a transmitter for transmitting a signal to a base station thereby establishing a connection therebetween. The signal contains a subscriber identification module number associated with the mobile phone therein. The alarm device includes a receiver, an alarm unit, a timing circuit, and a microprocessor. The receiver is configured for receiving the signal transmitted from the transmitter of the mobile phone, wherein the signal is receivable by the receiver within a predetermined, limited distance from the mobile phone. The alarm unit is configured for generating an alarm signal. The timing circuit is configured for measuring a predetermined time duration and triggering the alarm unit upon elapse of the predetermined time duration. The microprocessor is configured for prestoring a subscriber identification module number therein, checking if the mobile phone identification number contained in the signal received by the receiver is identical with the prestored subscriber identification module number, and resetting the predetermined time duration of the timing circuit if the mobile phone identification number contained in the signal received by the receiver is identical with the prestored subscriber identification module number.

The above and other features of the invention, including various novel details of construction and combination of parts, will now be more particularly described with reference to the accompanying drawings, in which:

### BRIEF DESCRIPTION OF THE DRAWINGS

FIG. 1 is a schematic, block diagram showing an alarming device in accordance with a first preferred embodiment of the present invention, together with a mobile phone associated therewith;

FIG. 2 is a flowchart showing a method for preventing loss or theft of a mobile phone in accordance with a second preferred embodiment of the present invention;

### DETAILED DESCRIPTION OF PREFERRED EMBODIMENTS

Reference will now be made to the drawings to describe the present invention in detail.

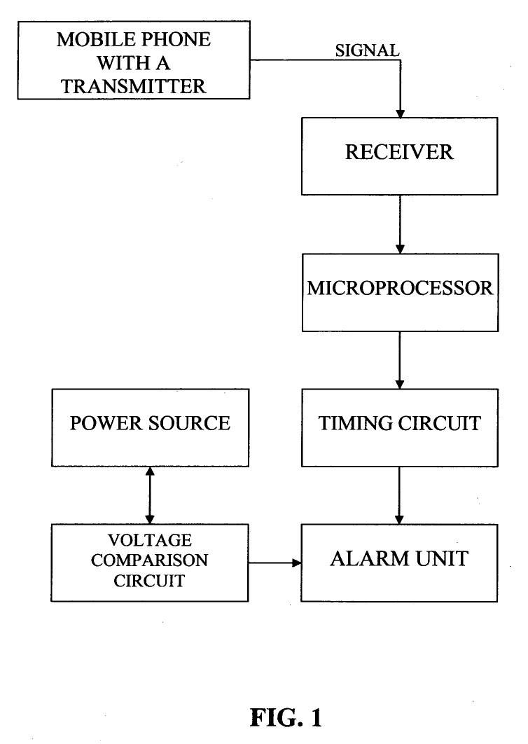

Referring to FIG. 1, an alarm device in accordance with an aspect of the present invention is provided. The alarm is for preventing loss of theft of a mobile phone. Generally, the mobile phone has a transmitter for continuously transmitting a signal to a base station thereby establishing a connection therebetween. In addition, the mobile phone is selected from the group consisting of a GSM mobile phone, a CDMA mobile phone, a 3G mobile phone. The signal contains a subscriber identification module number associated with the mobile phone. In the illustrated embodiment, the subscriber identification module number is a mobile phone number. The alarm device includes a receiver, an alarm unit, a timing circuit, and a microprocessor.

The receiver is configured for receiving the signal transmitted from the transmitter of the mobile phone only if the receiver is located within a predetermined distance from the mobile phone. It is recognized that a signal strength of the signal transmitted from the mobile phone decreases with increasing distance away therefrom. Therefore, the receiver may be configured in a manner such that the signal transmitted from the transmitter of the mobile phone is receivable by the receiver only within a predetermined limited distance from the mobile phone. The predetermined limited distance may be for example in the range from 0.5 m to 10 m.

The alarm unit is configured for generating an alarm signal. The alarm signal may be in a form selected from the group consisting of a sound alarm signal, a visual alarm signal, a vibration alarm signal and any combination thereof.

The timing circuit is configured for measuring a predetermined time duration and triggering the alarm unit upon elapse of the predetermined time duration. The predetermined time duration may be for example in the range from 10 seconds to 5 minutes. The microprocessor is configured for prestoring a subscriber identification module number therein, checking if the mobile phone identification number contained in the signal received by the receiver is identical with the prestored subscriber identification module number, and resetting the predetermined time duration of the timing circuit if the mobile phone identification number contained in the signal received by the receiver is identical with the prestored subscriber identification module number.

The alarm device may further includes a battery and a voltage comparing circuit. The battery is configured for powering the alarm device. The voltage comparing circuit is configured for monitoring a voltage of the battery, and triggering the alarm unit if the voltage of the battery is lower than a predetermined comparison voltage.

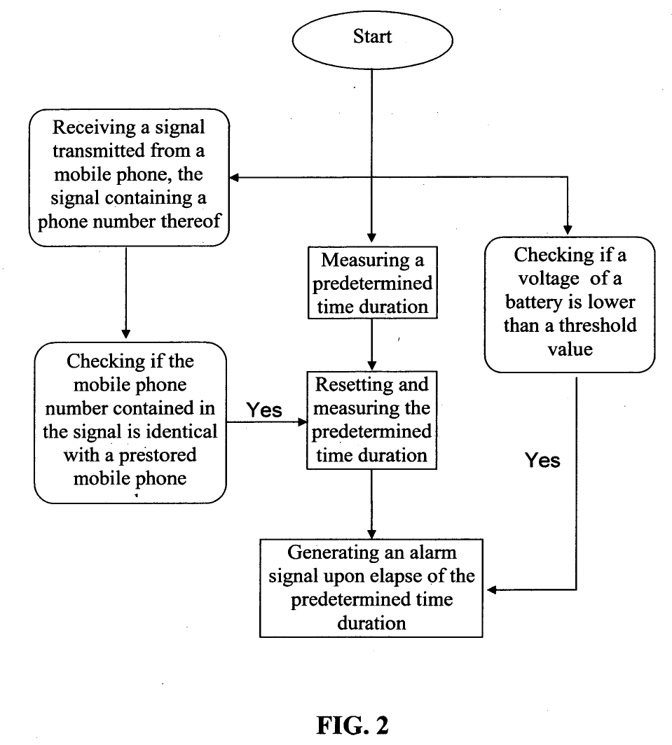

Referring to FIG. 2, an operation process of the alarm device is illustrated. The subscriber identification module number, e.g. the mobile phone number is prestored in the microprocessor. Once the alarm device is switched on, the receiver continuously receives the signal transmitted from the transmitter of the mobile phone, and the timing circuit continuously measures a predetermined time duration. The microprocessor then checks if the mobile phone number contained in the signal received by the receiver is identical with the prestored mobile phone number. If yes, the microprocessor reset the predetermined time duration and starts to measure the predetermined time duration over again. The timing circuit triggers the alarm unit, upon elapse of the predetermined time duration. Namely, the alarm signal is generated when the receiver hasn't received the signal containing the same phone number as the prestored phone number for the predetermined time duration.

If the voltage_comparison circuit is provided, the voltage comparison circuit monitors the voltage of the battery, and triggers the alarm unit if the voltage of the battery is lower than a predetermined comparison voltage

Although the present invention has been described with reference to a specific embodiment, it should be noted that the described embodiment is not necessarily exclusive and that various changes and modifications may be made to the described embodiment without departing from the scope of the invention as defined by the appended claims.

What is claimed is:

1. An alarm device for a mobile phone, the mobile phone having a transmitter for transmitting a signal to a base station thereby establishing a connection therebetween, the signal containing a subscriber identification module number associated with the mobile phone, the alarm device comprising:
a receiver configured for receiving the signal transmitted from the transmitter of the mobile phone only if the receiver is located within a predetermined distance from the mobile phone;
an alarm unit configured for generating an alarm signal;
a timing circuit configured for measuring a predetermined time duration and triggering the alarm unit upon elapse of the predetermined time duration; and
a microprocessor configured for prestoring a subscriber identification module number therein, checking if the mobile phone identification number contained in the signal received by the receiver is identical with the prestored subscriber identification module number, and resetting the predetermined time duration of the timing circuit if the mobile phone identification number contained in the signal received by the receiver is identical with the prestored subscriber identification module number.

2. The alarm device as claimed in claim 1, further comprising a battery configured for powering the alarm device, and a voltage comparing circuit configured for monitoring a voltage of the battery, and triggering the alarm unit if the voltage of the battery is lower than a predetermined comparison voltage.

3. The alarm device as claimed in claim 1, wherein the alarm signal is in a form selected from the group consisting of a sound alarm signal, a visual alarm signal, a vibration alarm signal and any combination thereof.

4. The alarm device as claimed in claim 1, wherein the alarm device is separately disposed from the mobile phone.

5. The alarm device as claimed in claim 1, wherein the mobile phone identification number is a mobile phone number of the mobile phone.

6. A method for preventing loss or theft of a mobile phone, the mobile phone having a transmitter for transmitting a signal to a base station thereby establishing a connection therebetween, the signal containing a subscriber identification module number associated with the mobile phone, the method comprising the steps of:
prestoring a subscriber identification module number therein;
measuring a predetermined time duration;
receiving the signal transmitted from the transmitter of the mobile phone only if within a predetermined distance from the mobile phone;
checking if the mobile phone identification number contained in the signal received is identical with the prestored subscriber identification module number;
resetting the predetermined time duration if the mobile phone identification number contained in the signal received is identical with the prestored subscriber identification module number; and
generating an alarm signal upon elapse of the predetermined time duration.

7. The method as claimed in claim 6, wherein the alarm signal is in a form selected from the group consisting of a sound alarm signal, a visual alarm signal, a vibration alarm signal and any combination thereof.

8. The method as claimed in claim 6, wherein the mobile phone identification number is a mobile phone number of the mobile phone.

9. A mobile phone set comprising:
a mobile phone including a transmitter for transmitting a signal to a base station thereby establishing a connection therebetween, the signal containing a subscriber identification module number associated with the mobile phone, and an alarm device including:
a receiver configured for receiving the signal transmitted from the transmitter of the mobile phone, wherein the signal is receivable by the receiver within a predetermined, limited distance from the mobile phone;
an alarm unit configured for generating an alarm signal;
a timing circuit configured for measuring a predetermined time duration and triggering the alarm unit upon elapse of the predetermined time duration; and
a microprocessor configured for prestoring a subscriber identification module number therein, checking if the mobile phone identification number contained in the signal received by the receiver is identical with the prestored subscriber identification module number, and resetting the predetermined time duration of the timing circuit if the mobile phone identification number contained in the signal received by the receiver is identical with the prestored subscriber identification module number.

10. The mobile phone set as claimed in claim 9, further comprising a battery configured for powering the alarm device, and a voltage comparing circuit configured for monitoring a voltage of the battery, and triggering the alarm unit if the voltage of the battery is lower than a predetermined comparison voltage.

11. The mobile phone set as claimed in claim 9, wherein the alarm signal is in a form selected from the group consisting of a sound alarm signal, a visual alarm signal, a vibration alarm signal and any combination thereof.

12. The mobile phone set as claimed in claim 9, wherein the mobile phone identification number is a mobile phone number of the mobile phone.

13. The mobile phone as claimed in claim 9, wherein the mobile phone is selected from the group consisting of a GSM mobile phone, a CDMA mobile phone, a 3G mobile phone.
